(19) United States
(12) Patent Application Publication
(10) Pub. No.: US 2012/0042726 A1
(43) Pub. Date: Feb. 23, 2012

(54) DEVICE AND METHOD FOR MEASURING A MOVING DISTANCE

(76) Inventors: Younghyeog JEON, Seoul (KR); Seungjin Jang, Seoul (KR); Youngdon Hwang, Seoul (KR)

(21) Appl. No.: 12/949,733

(22) Filed: Nov. 18, 2010

(30) Foreign Application Priority Data
Aug. 23, 2010 (KR) PCT/KR2010/005595

(51) Int. Cl. G01P 15/00

(52) U.S. Cl. 73/490

(57) ABSTRACT

A device and a method for measuring a moving distance are provided. More particularly, a device for measuring a total moving distance according to an embodiment of the invention includes a mounting module to be attached to a specific portion of a moving object, a sensor module configured to sense an acceleration of the moving object, a controller configured to: measure a moving speed based on the acceleration, initialize the moving speed at a at least one of substantial stop states, calculate each of a plurality of unit moving distances, wherein at least one of the plurality of substantial stop states occurs when an absolute value of the acceleration is smaller than a predetermined threshold value, and a communication unit configured to transmit information including the moving speed and the total moving distance, and receive health information.

### CROSS-REFERENCE TO RELATED APPLICATIONS

This application is a Continuation of PCT International Application No. KR2010/005595 filed on Aug. 23, 2010, which is hereby expressly incorporated by reference into the present application.

### BACKGROUND OF THE INVENTION

1. Field of the Invention

The present invention relates to a device and a method for measuring a moving distance for measuring a total moving distance based on a plurality of unit moving distances.

2. Background of the Invention

Nowadays, with increasing interests in one's own heath, a demand for an exercise for better health has gradually surfaced across society. Particularly, due to busy business and modern lifestyles, people prefer a type of exercises that can be taken their convenience, such as a walk or a run.

Accordingly, a device for measuring a moving distance such as a pedometer for notifying an exercise amount or a moving distance of such a walk or a run is suggested. In general, a conventional pedometer measures the total number of steps taken by detecting a vibration according to a user's movement. However, the pedometer notifies only the total number of steps, or calculates a moving distance using the total number of steps and an estimated value of a stride. Therefore, there is a need for a pedometer that accurately measures a moving distance taking in an account an error caused by a stride difference of each user.

### SUMMARY OF THE INVENTION

Accordingly, an object of the present invention is to address the above-noted and other problems. Therefore, an object of the present invention is to provide a device and a method for measuring a moving distance that can provide reliable exercise information.

Another object of the present invention is to provide a device and a method for measuring a moving distance that can measure an accurate moving distance.

Another object of the present invention is to provide a device and a method for measuring a moving distance that can minimize errors generated when measuring a moving distance.

Another object of the present invention is to provide a device and a method for measuring a moving distance that can remove accumulation of errors generated every step.

The object of the present invention is not limited to the above-described objects and the other objects will be understood by those skilled in the art from the following description.

In accordance with an aspect of the present invention, a device for measuring a moving distance, comprises: a sensor module configured to sense an acceleration, and a controller configured to: measure a moving speed based on the acceleration, initialize the moving speed at a substantial stop state, calculate each of a plurality of unit moving distances between the substantial stop states based on the moving speed, and calculate a total moving distance by adding up the plurality of unit moving distances.

In accordance with another aspect of the present invention, a device for measuring a moving distance includes: a sensor module configured to sense an acceleration, and a controller configured to obtain each of a plurality of unit moving distances, and obtain a total moving distance by adding up the plurality of unit moving distances. Here, the controller obtains a time point of a substantial stop state based on the acceleration, the time point of the substantial stop state including a step start point and a step end point, initializes a moving speed of the step start point to a predetermined value, and obtain a unit moving distance based on the moving speed of the step start point and the acceleration from the step start point to the step end point.

In accordance with another aspect of the present invention, a device for measuring a moving distance includes: a sensor module configured to sense an acceleration, and a controller configured to obtain each of a plurality of unit moving distances, and obtain a total moving distance by adding up the plurality of unit moving distances. Here, the controller obtains the time point of the substantial stop state when an absolute value of the acceleration is smaller than a threshold value or when an absolute value of the acceleration is smaller than the threshold value for a predetermined time period, and determines a step start point and a step end point among the time point of the substantial stop state, initializes the moving speed of the step start point to a predetermined value, and obtains a unit moving distance based on the moving speed of the step start point and the acceleration from the step start point to the step end point.

In accordance with another aspect of the present invention, a device for measuring a moving distance includes: an input module configured to receive an input, a sensor module configured to sense an acceleration, and a controller configured to obtain each of a plurality of unit moving distances, and obtain a total moving distance by adding up the plurality of unit moving distances. Here, the controller selects a moving mode through the input module, determines at least one of a threshold value and a predetermined time period based on the moving mode, obtains a time point of the substantial stop state when an absolute value of the acceleration is smaller than a threshold value or when an absolute value of the acceleration is smaller than the threshold value for a predetermined time period, and determines a step start point and a step end point among the time point of the substantial stop states, initializes a moving speed of the step start point to a predetermined value, and obtains a unit moving distance based on the moving speed of the step start point and acceleration from the step start point to the step end point. Here, the moving mode includes at least one of a walking mode, a race-walking mode, a running mode, a stair-ascending mode, and a stair-descending mode.

In accordance with another aspect of the present invention, a device for measuring a moving distance includes: a sensor module configured to sense at least one of a horizontal acceleration and a vertical acceleration, and a controller configured to obtain each of a plurality of unit moving distances and obtain a total moving distance by adding up the plurality of unit moving distances. Here, the controller obtains a time point of the substantial stop state when a vertical acceleration is constant for a predetermined time period, determines a step start point and a step end point based on the vertical acceleration, initializes a moving speed of the step start point to a predetermined value, and determines a unit moving distance based on the moving speed of the step start point and a horizontal acceleration from the step start point to the step end point.

In accordance with another aspect of the present invention, a method of measuring a moving distance, the method comprising: sensing an acceleration, calculating each of a plurality of unit moving distances, and calculating a total moving distance by adding up the plurality of unit moving distances. Here, the calculating each of a plurality of unit moving distances comprises: obtaining a time point of the substantial stop state based on the acceleration, the time point of the substantial stop state including a step start point and a step end point, initializing a moving speed of the step start point to a predetermined value, and calculating the each of the plurality of the unit moving distances based on the moving speed of the step start point and the acceleration from the step start point to the step end point.

In accordance with another aspect of the present invention, a method of measuring a moving distance, the method includes: sensing an acceleration, obtaining each of a plurality of unit moving distances, and obtaining a total moving distance by adding up the plurality of unit moving distances. Here, the obtaining of each of a plurality of unit moving distances includes: determining a step start point and a step end point of time points determined as a user substantially stops based on the acceleration, initializing a moving speed of the step start point to a predetermined value, and measuring a unit moving distance based on the moving speed of the step start point and acceleration from the step start point to the step end point. Here, the measuring of a unit moving distance includes acquiring a moving speed from the step start point to the step end point using the moving speed of the step start point and acceleration from the step start point to the step end point and acquiring a unit moving distance using the moving speed from the step start point to the step end point. In this case, the acquiring of a moving speed includes acquiring a change amount of the moving speed by integrating acceleration from the step start point to the step end point with respect to a time and acquiring the moving speed from the step start point to the step end point based on the moving speed of the step start point and a change amount of the moving speed, and at the acquiring of a unit moving distance, a unit moving distance is acquired by integrating the moving speed from the step start point to the step end point with respect to a time.

In accordance with another aspect of the present invention, a device for measuring a moving distance includes a mounting module to be attached to a specific portion of a moving object, a sensor module configured to sense an acceleration of the moving object, a controller configured to: measure a moving speed based on the acceleration, initialize the moving speed at a at least one of substantial stop states, calculate each of a plurality of unit moving distances, wherein at least one of the plurality of substantial stop states occurs when an absolute value of the acceleration is smaller than a predetermined threshold value, and a communication unit configured to transmit information including the moving speed and the total moving distance, and receive health information.

In accordance with another aspect of the present invention, a method of measuring a moving distance includes installing a device to a moving object via a mounting module of the device, selecting a moving mode on the device, sensing an acceleration of the moving object via a sensing module of the device, calculating each of a plurality of unit moving distances using the sensed acceleration and the selected moving mode, and calculating a total moving distance by adding up the plurality of unit moving distances.

In accordance with another aspect of the present invention, a method of measuring a moving distance includes installing a device to a moving object via a mounting module of the device, selecting a moving mode on the device, sensing an acceleration of the moving object via a sensing module of the device, obtaining a time point of the substantial stop state based on the acceleration, the time point of the substantial stop state including a step start point and a step end point, initializing a moving speed of the step start point to a predetermined value, determining the moving speed from the step start point to the step end point based on the acceleration and the moving speed of the step start point, calculating each of the plurality of the unit moving distances based on the moving speed of the step start point and the acceleration from the step start point to the step end point, and calculating a total moving distance by adding up the plurality of unit moving distances.

According to the present invention, a device and a method for measuring a moving distance can provide reliable exercise information and can measure an accurate moving distance. Further, the device and a method for measuring a moving distance can minimize errors generating when measuring a moving distance and remove accumulation of errors generating every step. Additionally, a more systematic and comprehensive health management can be performed because the device for measuring a moving distance interlocks with a health management server. Also, a user can lead a more healthy life, and waste of unnecessary medical expenses in society can be reduced because an exercise effect improves through right health management. The object of the present invention is not limited to the above-described objects and the other objects will be understood by those skilled in the art from the following description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a diagram illustrating a configuration of a health management system according to the present invention;

FIG. 2 is a diagram illustrating a configuration of a device for measuring a moving distance according to the present invention;

FIG. 3 is a perspective view illustrating a device for measuring a moving distance according to an exemplary embodiment of the present invention;

FIG. 4 is a diagram illustrating an installing position of a device for measuring a moving distance according to an exemplary embodiment of the present invention;

FIG. 5 is a top plan view illustrating an input module according to an exemplary embodiment of the present invention;

FIG. 6 is a top plan view illustrating an output unit according to an exemplary embodiment of the present invention;

FIG. 7 is a flowchart illustrating a method of measuring a moving distance according to an exemplary embodiment of the present invention;

FIG. 8 is a graph illustrating a sequential position of both feet when a user walks according to an exemplary embodiment of the present invention;

FIG. 9 is a graph illustrating acceleration detected when moving a unit moving distance in a method of measuring a moving distance according to an exemplary embodiment of the present invention;

FIG. 10 is a graph illustrating acceleration detected in a walking mode in a method of measuring a moving distance according to an exemplary embodiment of the present invention;

FIG. 11 is a graph illustrating acceleration detected in a running mode in a method of measuring a moving distance according to another exemplary embodiment of the present invention;

FIG. 12 is a graph illustrating a step start point and a step end point in a method of measuring a moving distance according to an exemplary embodiment of the present invention;

FIG. 13 is a graph illustrating initialization of a moving speed at a step start point in a method of measuring a moving distance according to an exemplary embodiment of the present invention;

FIG. 14 is a graph illustrating a total moving distance measured in a method of measuring a moving distance according to an exemplary embodiment of the present invention; and

FIG. 15 is a graph illustrating a method of measuring a moving distance according to an exemplary embodiment of the present invention.

### DETAILED DESCRIPTION OF THE INVENTION

Reference will now be made in detail to the preferred embodiments of the present invention, examples of which are illustrated in the accompanying drawings.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

Hereinafter, embodiments of the present invention will be described in detail with reference to the accompanying drawings.

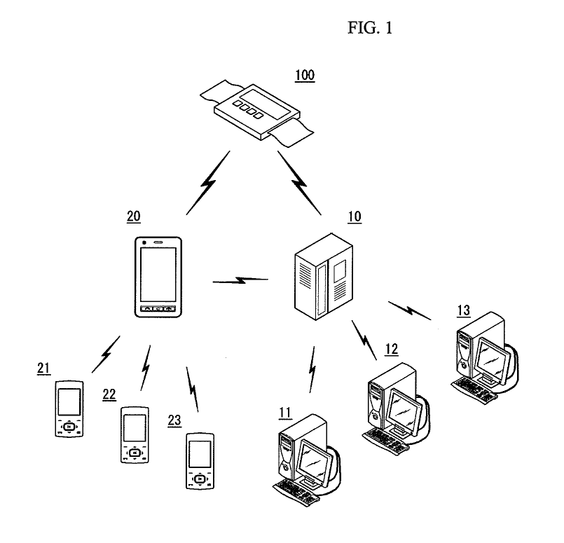

A health management system according to the present invention will be described with reference to FIG. 1. FIG. 1 is a diagram illustrating a configuration of a health management system according to an embodiment of the present invention.

The health management system manages a user's health. The health management system includes at least one of diet management and exercise management. In order to improve the user's health, the user can manage his/her diet and exercise amount more effectively using the health management system.

As shown in FIG. 1, the health management system includes a health management server 10, a mobile communication terminal 20, and a device for measuring a moving distance 100. The health management server 10 may be a server that collects, manages, analyzes, and provides health management information in order to manage the user's health. The mobile communication terminal 20 can transmit and receive health management information to and from the health management server 10 and/or the device for measuring a moving distance 100. The device for measuring a moving distance 100 measures the user's moving distance, which is the amount of distance that the user moved while the user uses the device for measuring the moving distance 100, and provides the moving distance to the user, which constitutes health management information.

The health management server 10, the mobile communication terminal 20, and the device for measuring a moving distance 100 share health management information. The health management information is exchanged between the health management system through wired and wireless communication networks in order to provide more effective and systematic health management.

Hereinafter, the health management server 10, the mobile communication terminal 20, and the device for measuring a moving distance 100 will be described. First, the health management server 10 collects, generates, manages, analyzes, and provides health management information for managing the user's health. Here, the health management information includes at least one of the user's personal information, diet information, and exercise information. The personal information may be the user's name, sex, age, height, weight, blood pressure, blood sugar, medical history, and other body information about the user's health. The diet information may be information about the user's meal amount, meal time, and intake calorie. The exercise information may be information about the user's exercise amount, exercise time, moving distance, total number of steps, consumption calorie, and target consumption calorie.

The health management server 10 receives the health management information from the user or from an external device such as the mobile communication terminal 20 or the device for measuring a moving distance 100. Alternatively, the health management server 10 may generate other health management information using some health management information. For example, the health management server 10 may calculate a target consumption calorie based on the user's age, weight, blood pressure, blood sugar, and intake calorie.

Referring to FIG. 1, the mobile communication terminal 20 transmits and receives the health management information to and from at least one of the health management server 10 and the device for measuring a moving distance 100. Here, the device for measuring a moving distance 100 directly communicates with the health management server 10 or shares information with the health management server 10 through the mobile communication terminal 20. Alternatively, the device for measuring a moving distance 100 and the mobile communication terminal 20 may be a single device. The device for measuring a moving distance 100 measures a moving distance of the user and provides health management information including the moving distance to the user. The device for measuring a moving distance 100 will be described later.

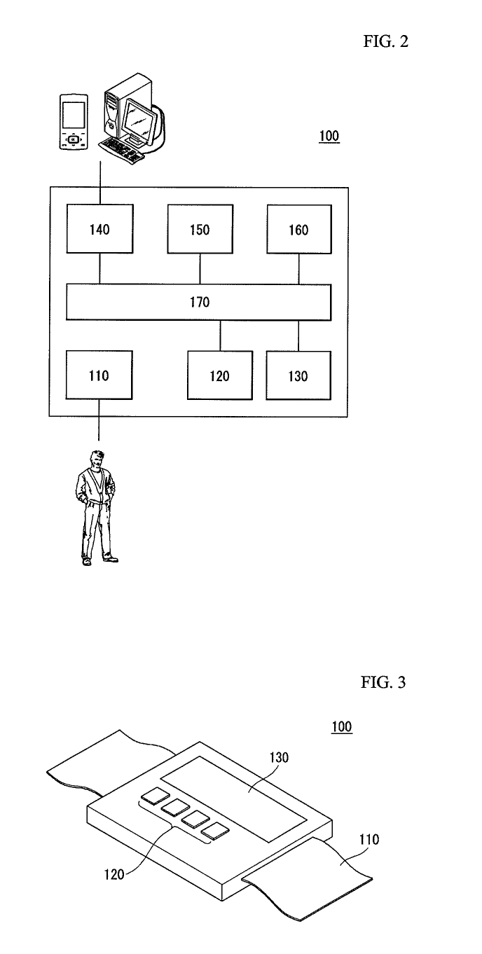

Hereinafter, a configuration of the device for measuring a moving distance 100 according to an embodiment of the present invention will be described with reference to FIGS. 2 and 3. FIG. 2 is a diagram illustrating a configuration of the device for measuring a moving distance 100 according to an embodiment of the present invention. FIG. 3 is a perspective view illustrating the device for measuring a moving distance 100 according to an embodiment of the present invention.

As shown in FIGS. 2 and 3, the device for measuring a moving distance 100 includes at least one of a mounting unit 110, an input module 120, an output unit 130, a communication unit 140, a sensor module 150, a storage unit 160, and a controller 170. The mounting unit 110 of the device for measuring a moving distance 100 can be mounted on a user or an object. The input module 120 is used for inputting information from the outside. The output unit 130 outputs information to the outside. The communication unit 140 performs communication with an external device. The sensor module 150 detects a motion of a user or an object. The storage unit 160 stores health management information. The controller 170 controls the units.

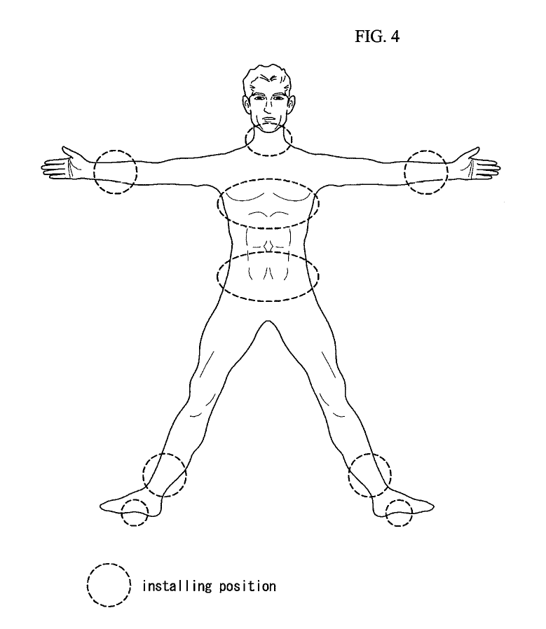

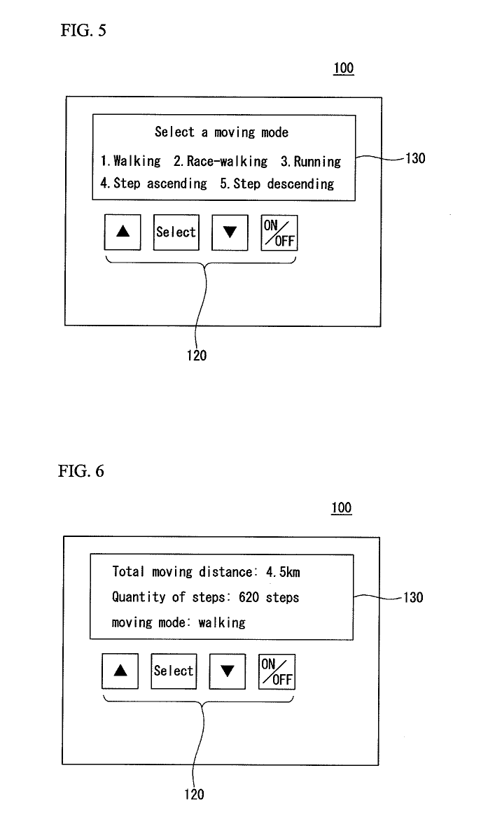

Hereinafter, the mounting unit 110, the input module 120, the output unit 130, the communication unit 140, the sensor module 150, the storage unit 160, and the controller 170 will be described with reference to FIGS. 4, 5, and 6. FIG. 4 is a diagram illustrating a installing position of the device for measuring a moving distance 100 according to an embodiment of the present invention, FIG. 5 is a top plan view illustrating the input module 120 according to an embodiment of the present invention, and FIG. 6 is a top plan view illustrating the output unit 130 according to an embodiment of the present invention.

First, the mounting unit 110 of the device for measuring a moving distance 100 can be mounted to the user or an object. For example, the mounting unit 110 may be mounted to a body part of an exercising user or a specific part of an object. As shown in FIG. 4, for example, the user may put the mounting unit 110 on his/her neck, wrist, chest, waist, ankle, and sole of a foot. Alternatively, the user may put the mounting unit 110 on his/her shoe or bottom piece of a shoe. Here, the mounting unit 110 can be an elastic body. When the mounting unit 110 is an elastic body, the mounting unit 110 of the device for measuring a moving distance 100 can be fixed to the user or the object in order to integrally move with the user or the object. Thereby, the sensor module 150 of the device for measuring a moving distance 100 can accurately detect a motion of the user or the object. Further, the mounting unit 110 formed with an elastic body may not be separated from a user or an object by movement having much vibration or shaking.

The user may use the input module 120 for inputting information including health management information from the outside. Here, the information may be at least one of the user's personal information, diet information, exercise information, target movement distance, target movement amount, target consumption calorie, and moving mode. As shown in FIG. 5, the user may select a moving mode that indicates a moving method of the user and the moving mode may include, for example, at least one of a walking mode, a race-walking mode, a running mode, a stair-ascending mode, and a stair-descending mode. Here, the input module 120 may include at least one of a button, a voice recognition device, and a touch screen.

As shown in FIG. 6, the output unit 130 outputs information to the outside. Here, the information may be at least one of the user's personal information, diet information, exercise information, present time, exercise time, entire movement distance, a total number of steps, exercise amount, consumption calorie, target movement distance, target exercise amount, target consumption calorie, and moving mode. Further, the output unit 130 may include at least one of a display, a loudspeaker, and a vibration device.

Referring back to FIG. 2, the communication unit 140 communicates information including health management information, with an external device. For example, the information may be at least one of the user's personal information, diet information, exercise time, entire movement distance, a total number of steps, exercise amount, consumption calorie, target movement distance, target exercise amount, target consumption calorie, and moving mode. Here, the external device may include at least one of the health management server 10 and the mobile communication terminal 20. The device for measuring a moving distance 100 can be a single device together with the mobile communication terminal 20 and the communication between the communication unit 140 and an external device may be wired communication or wireless communication through a communication network. The wired communication may be performed with, for example, RS-232 or an USB method and the wireless communication may be performed with, for example, Wi-Fi, Bluetooth, and Zigbee methods.

The sensor module 150 detects a motion, for example, a motion of the device for measuring a moving distance 100. For instance, when the user puts the device for measuring a moving distance 100 on himself/herself or the device for measuring a moving distance 100 is mounted on an object, the device for measuring a moving distance 100 moves integrally with the user or the object at a mounted position. At this point, the sensor module 150 can sense a movement of user or object on which the device 100 is mounted, and measures the motion. Here, the sensor module 150 can be at least one of an acceleration sensor, a gravity sensor, a terrestrial magnetism sensor, a gyro sensor, and a motion sensor. For example, the sensor module 150 may include an acceleration sensor to detect acceleration of a mounted point. That is, the acceleration sensor detects at least one of acceleration in perpendicular and horizontal directions. The acceleration sensor may also be a three-axis acceleration sensor that detects acceleration in a perpendicular direction and acceleration of two components of a horizontal direction.

Referring to FIG. 2, the storage unit 160 stores information. The storage unit 160 may be a memory, such as a flashlight memory, a RAM, a ROM, and a hard disk. Further, the information may be health management information, such as, at least one of a user's personal information, diet information, exercise time, entire movement distance, total number of steps, exercise amount, consumption calorie, target movement distance, target exercise amount, target consumption calorie, and moving mode. The information may be acquired through the input module 120 or the communication unit 140, or stored information generated in the controller 170. The storage unit 160 may be included in the device for measuring a moving distance 100 or detachable from the device for measuring a moving distance 100.

Further, the controller 170 calculates the total moving distance and/or controls a configuration of the device for measuring a moving distance 100. A detailed description of the controller 170 will be described later in a method of measuring a moving distance.

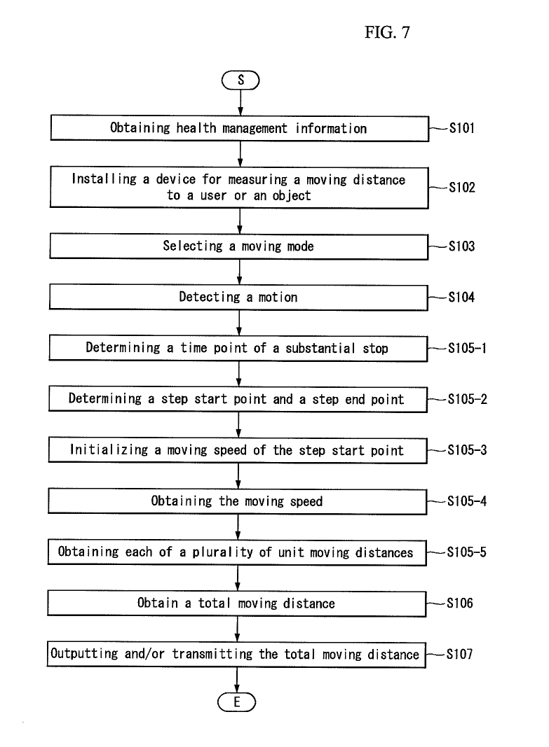

Hereinafter, a method of measuring a moving distance according to the present invention will be described with reference to FIGS. 1 and 7. FIG. 7 is a flowchart illustrating a method of measuring a moving distance according to an embodiment of the present invention. Hereinafter, a method of measuring a moving distance according to an embodiment of the present invention will be described using a device for measuring a moving distance 100. The method of measuring a moving distance according to the present invention is not limited by the device for measuring a moving distance 100 and can use other apparatuses for performing the same function as that of the device for measuring a moving distance 100 according to the present invention.

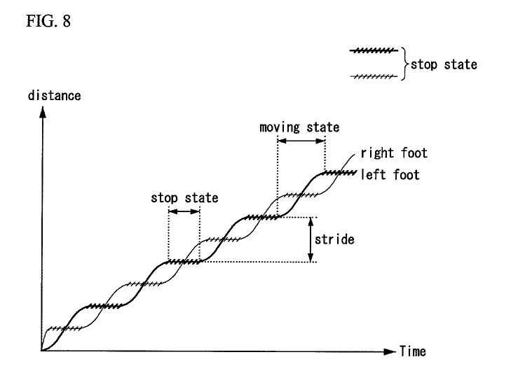

The method of measuring a moving distance according to an embodiment of the present invention includes at least one of step of acquiring health management information (S101), step of mounting a device for measuring a moving distance to a user or an object (S102), step of selecting a moving mode (S103), step of detecting a motion (S104), step of acquiring each of a plurality of unit moving distances based on the motion (S105), step of acquiring health management information including a total moving distance by adding up the acquired plurality of unit moving distances (S106), and step of outputting the acquired health management information or transmitting the acquired health management information to an external device (S107). Here, the step of acquiring the unit moving distance includes at least one of step of determining a substantially stopped time point based on the motion (S105-1), step of determining a step start point and a step end point of the time points (S105-2), step of initializing a moving speed at the step start point (S105-3), step of acquiring a moving speed from the step start point to the step end point based on the detected motion and the moving speed at the step start point (S105-4), and step of acquiring a unit moving speed based on the moving speed from the step start point to the step end point (S105-5). Such a method of measuring a moving distance may include all the above-described steps or may selectively include only some steps. Hereinafter, each step that can be included in a method of measuring a moving distance according to the present invention will be described with reference to FIGS. 8-15.

Referring to FIG. 8, the device for measuring a moving distance 100 first obtains health management information (S101). As described above, the health management information includes at least one of a user's personal information, diet information, and exercise information. The personal information may include the user's name, sex, age, height, weight, blood pressure, blood sugar, medical history, and other body information about the user's health. The diet information may include the user's meal amount, meal time, and intake calorie. The exercise information may include the user's exercise amount, exercise time period, moving distance, total number of steps, consumption calorie, and target consumption calorie.

As shown in FIG. 1, the controller 170 receives the health management information from an external device through the communication unit 140, directly receives information from the user through the input module 120,or generates other health management information using some health management information. For example, the controller 170 may calculate a target consumption calorie using an intake calorie of the user and personal information. Here, the received, input, or generated information is stored in the storage unit 160.

Next, the device for measuring a moving distance 100 is mounted to an object to be measured (S102). The object to be measured may be, for example, a person, an animal, or anything that moves. As shown in FIG. 4, the user may put the device for measuring a moving distance 100 on a part of his or her body using the mounting unit 110. Here, the part of his or her body is where the user repeatedly or periodically makes a movement and stoppage when the user moves. The device for measuring a moving distance 100 mounted to the part of the user's body may easily initializing a speed every time the user substantially stop at a point while moving. Further, the device for measuring a moving distance 100 may measure a unit moving distance by initializing a speed, as described later.

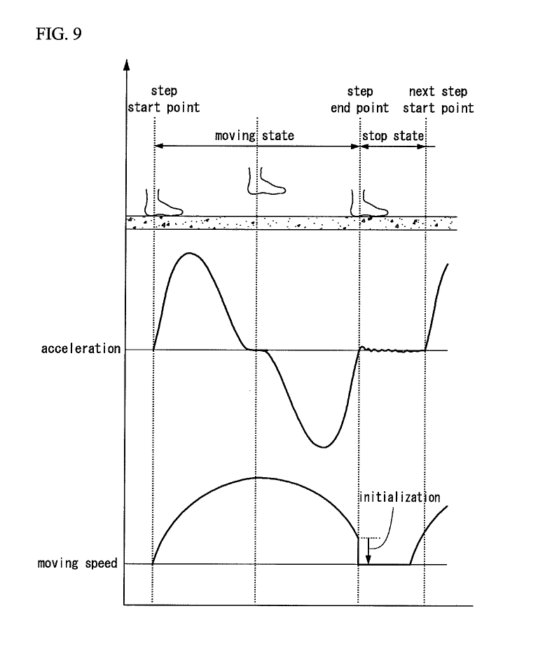

FIG. 8 is a graph illustrating a sequential position of a sole of feet of a user when the user walks. Here, a solid line indicates one foot, for example, a left foot, and a dotted line indicates another foot, for example, a right foot. Further, a slashed portion indicates a state where feet are grounded and stopped. As shown in FIG. 8, when walking, the user may move while crossing both feet. That is, one foot advances while alternating a stop state and a moving state, and another foot advances while alternating a stop state and a moving state alternately with the one foot. When the user moves, an acceleration according to a unit moving distance can be detected, as shown in FIG. 9. As shown in FIG. 9, when the device for measuring a moving distance 100 is mounted to an ankle or a sole of a foot of the user, while the user walks, an initialization of measure a speed of a unit moving distance is performed at a time point at which a sole of a foot of the user reaches the ground. That is, whenever the sole of the foot of the user reaches the ground, the speed will be initialized to an accurate detection of the user's speed.

Referring to FIG. 8, the device for measuring a moving distance 100 selects a moving mode (S103). As shown in FIG. 5, the moving mode is a method that a user moves and may include at least one of a walking mode, a race-walking mode, a running mode, a stair-ascending mode, and a stair-descending mode. Here, the controller 170 receives an input of a moving mode from the user through the input module 120 and selects a moving mode based on the input. The moving mode is used for calculation of health management information or determination of a stop time point to be described later. A selection of the moving mode may be determined according to the input by the input module 120. Alternatively, the controller 170 can select the moving mode based on a pattern of a user's motion detected by the sensor module 150 to be described later.

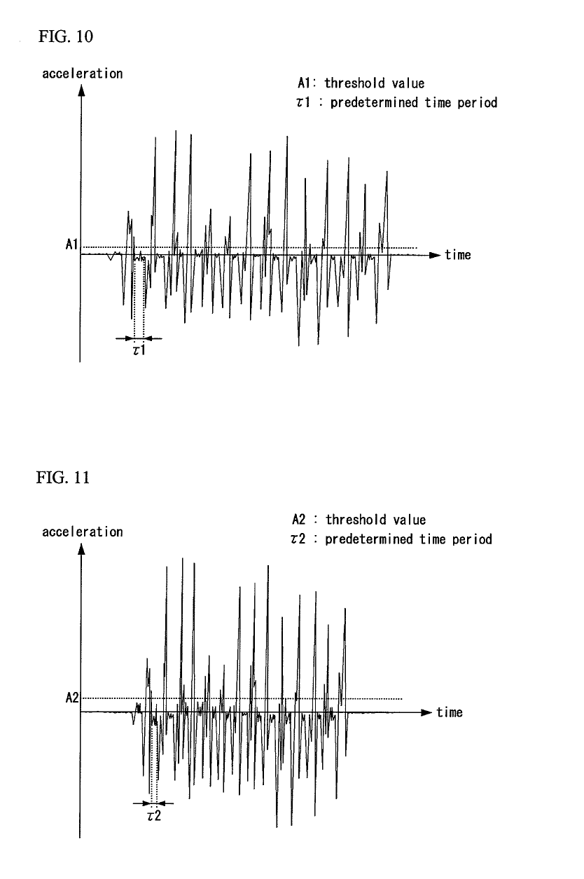

Next, the device for measuring a moving distance 100 detects a motion by the sensor module 150 (S104). The sensor module 150 detects a motion by detecting acceleration according to a user's movement. As shown in FIGS. 10 and 11, the acceleration may be different according to the user's moving mode. For example, as shown in FIG. 10, a pattern of acceleration detected when the user walks is different a pattern of acceleration detected when the user runs, as shown in FIG. 11.

Moreover, the sensor module 150 detects acceleration of at least one direction. For example, the sensor module 150 may detect acceleration of a perpendicular direction and acceleration of a horizontal direction. Alternatively, the sensor module 150 may be a three-axis acceleration sensor. The three-axis acceleration sensor can detect acceleration of a perpendicular direction and acceleration of two components of a horizontal direction. Here, the acceleration of a perpendicular direction is acceleration of substantially 9.8 m/s in a gravity direction even when no acceleration exists. As such, a stop time point when a foot reaches the ground can be only the acceleration of a horizontal direction. Here, when acquiring the stop time point the horizontal direction when the foot reaches the ground, it can be clearly seen whether a user's feet is grounded regardless of movement of a horizontal direction of a riding means even when obtaining a moving distance of the user within the riding means moving in a horizontal direction.

Next, the device for measuring a moving distance 100 acquires each of a plurality of unit moving distances based on the motion. Here, the unit moving distance is a moving distance for calculating a total moving distance and is a unit moving distance from the stop time point to a next stop time point. Specifically, when the user walks, the user repeatedly passes a time point at which one foot is grounded, a time point at which one foot takes off the ground and moves, and a time point at which one foot is again grounded. Here, a time point at which one foot is grounded is a step start point, and a time point at which one foot is again grounded is a step end point. A unit moving distance is a moving distance from the step start point to the step end point. This unit moving distance corresponds to a stride.

Here, acquiring a unit moving distance includes all or some of step of determining a time point that substantially stops based on motion (S105-1), step of determining a step start point and a step end point of time points (S105-2), step of initializing a moving speed at the step start point (S105-3), step of acquiring a moving speed from the step start point to the step end point based on the detected motion and the moving speed of the step start point (S105-4), and step of acquiring a unit moving distance based on the moving speed from the step start point to the step end point (S105-5). Hereinafter, each steps included at step of acquiring the unit moving distance (S105) will be described.

The acquiring the unit moving distance includes, a step of first the controller 170 determining a substantially stopped time point based on the detected motion (S105-1). The substantially stopped time point is a time point when an absolute value of acceleration reaches a predetermined threshold value or less. Alternatively, the substantially stopped time point may be a time point at which an absolute value of acceleration is sustained to a predetermined threshold value or less for a predetermined time period.

For example, as shown in FIGS. 10 and 11, time points are divided into a stop time point or a moving time point according to whether or not an absolute value of the detected acceleration is sustained to a predetermined threshold value or less for a predetermined time period. Referring to FIG. 10, a threshold value is A1 and a predetermined time is τ1 in a walking mode, whereas a threshold value is A2 and a predetermined time is τ2 in a running mode in FIG. 11. Here, the sensor module 150 detects acceleration of a perpendicular direction and acceleration of a vertical direction. When the user is determined that the user stopped using acceleration of a perpendicular direction because the feet is moving, acceleration of gravity always operates in a perpendicular direction and thus acceleration of a perpendicular direction in which acceleration of gravity is amended should be used. In other words, a stop state is determined according to whether an absolute value of amended acceleration of a perpendicular direction that extracts 9.8 m/s from the detected acceleration of a perpendicular direction is a threshold value or less.

Here, at least one of a threshold value and a predetermined time is determined according to the selected moving mode. For example, the threshold value may be in decreasing order from a walking mode, a race-walking mode, to a running mode. For another example, a predetermined time may be a smaller value in a decreasing order from the walking mode, the race-walking mode, to the running mode.

For example, as shown in FIGS. 10 and 11, A1, a threshold value in a walking mode, is smaller than A2, a threshold value in a running mode. Further, τ1, a predetermined time period in a walking mode, is longer than τ2, a predetermined time period in a running mode. This is because an acceleration value of running is larger than that of walking, and a time period in which feet are grounded in a running case is longer than a time period in which feet are grounded when walking. As a threshold value and a predetermined time are adjusted according to the user's movement, measuring of health management information of the user can be accurately determined, by measuring whether or not the user or the object is in a stop state to correspond to a characteristic of a moving mode.

As described above, when the sensor module 150 detects acceleration of a perpendicular direction and/or a horizontal direction, a substantially stopped time point is determined based on at least one of acceleration of the perpendicular and the horizontal direction. When the user walks or runs, the movement is of a horizontal direction. Therefore, a more accurate result can be obtained by determining a stop time point using acceleration of a perpendicular direction. Further, when this determination is based on acceleration of a horizontal direction, the quantity of acceleration sensors can be reduced and thus a production cost can be reduced. In addition, when a user rides on an object moving in a horizontal direction, acceleration of a perpendicular direction is not influenced by acceleration of a horizontal direction of the moving object, which provides a more accurate result.

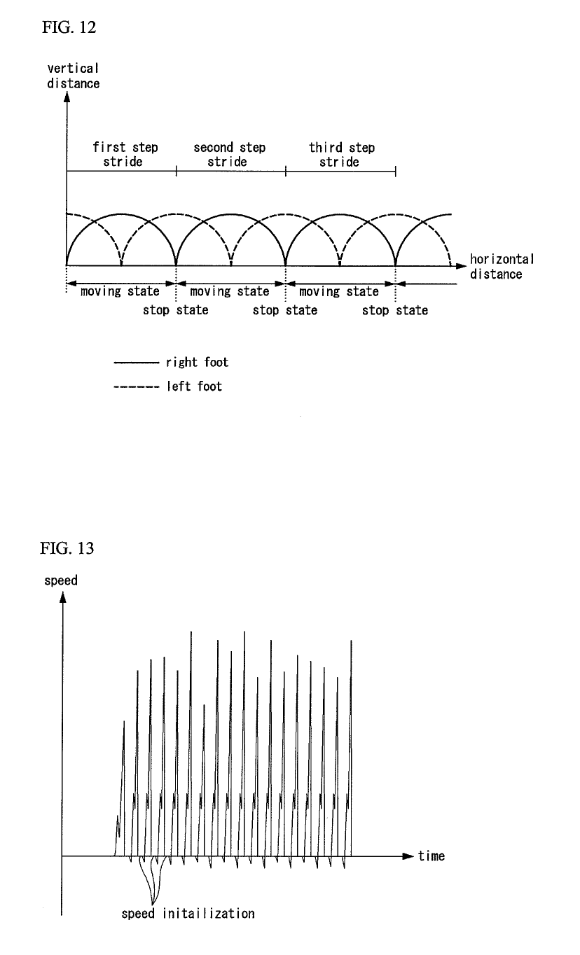

Next, the device for measuring a moving distance 100 determines a step start point and a step end point (S105-2). Here, the controller 170 determines which one should be the step start point and the step endpoint. Here, when a user moves while repeating steps, a step end point may become a step start point of a next step. For example, as shown in FIG. 12, when the user walks, a first step is from a first step start point to a first step end point. Here, a next step, i.e., a second step, is from a second step start point, which is the first step end point, to a second step end point and a third step is from a third step start point using a step end point of the second step as a step start point to a third end point, and so on.

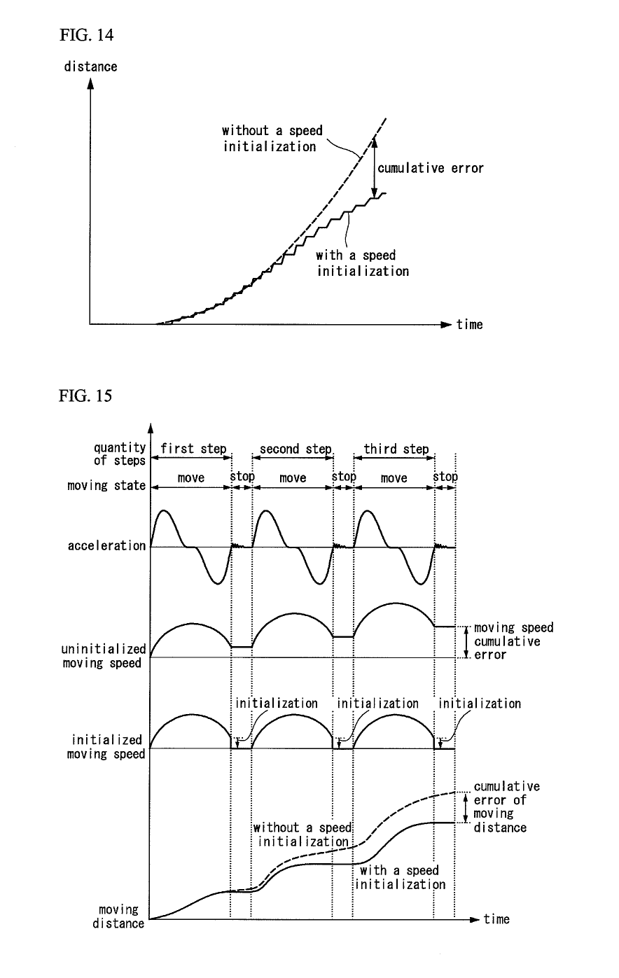

Next, the device for measuring a moving distance 100 initializes a moving speed at a step start point (S105-3). The controller 170 initializes a moving speed at the determined step start point. For example, as shown in FIG. 13, the controller 170 may set the moving speed of the step start point to a predetermined value. Such a predetermined value may be ‘0’. By initializing a moving speed every step start point, an error can be prevented from being accumulated when calculating the moving speed by acceleration and accurately acquire a total moving distance. FIG. 14 illustrates a comparative graph showing a total moving distance acquired based on the moving speed when a speed is not initialized and when a speed is periodically initialized. Referring to FIG. 14, it shows that when the moving speed is periodically initialized, an error for determining the user's moving distance is reduced.

Next, the device for measuring a moving distance 100 acquires a moving speed from a step start point to a step end point speed based on the detected acceleration and a moving speed of a step start point (S105-4). Here, the controller 170 including an integration circuit performs step of acquiring a moving speed from the step start point to the step end point. The controller 170 acquires a change amount of the moving speed from a step start point to a specific time point by integrating the detected acceleration with respect to a time from the step start point to the specific time point. Here, the controller 170 acquires a moving speed of a specific time point by adding up a moving speed of the step start point and a change amount of a moving speed until the specific time point. When the moving speed of the step start point is initialized, the moving speed may be a predetermined value the moving speed from the step start point to the step end point can be sequentially acquired based on the detected acceleration. This is represented by Equation 1. First, a change amount of a moving speed from the step start point to the specific time point is described as follows.

Δv(tᵢ→t)=∫ₜ_{ᵢ}^{t}a(t)dt [Equation 1]

In Equation 1, a(t) is detected acceleration, t is a specific time point, tᵢ is a time of a step start point, and Δv is a time change amount until a specific time point. That is, a sequential change amount of the speed is obtained by integrating sequential acceleration from a step start point to a specific time point. By adding an initial moving speed to a sequential change amount of a moving speed, a sequential moving speed can be acquired.

v(t)=vᵢ+Δv(tᵢ→t) [Equation 2]

In Equation 2, v(t) is a sequential moving speed, and vᵢ is a speed at a step start point. Because vᵢ is initialized to a predetermined value, i.e., ‘0’, a sequential moving speed is finally a sequential change amount of a moving speed from a step start point to a specific time point.

Referring to FIG. 8, the device for measuring a moving distance 100 acquires the unit moving distance based on the acquired moving speed from the step start point to a step end point (S105-5). The controller 170 acquires a unit moving distance from a step start point to a step end point, (i.e., a unit moving distance by integrating the acquired moving speed from the step start point) to a step end point with a time from a step start point to a step end point. This is represented by Equation 3.

Δs(tᵢ→t)=∫ₜ_{ᵢ}^{t}v(t)dt [Equation 3]

In Equation 3, Δs is a moving distance from a step start point to a specific time point. As can be seen in Equation 3, such a moving distance can be obtained by integrating the moving speed with a time.

Δs_{if}=Δs(tᵢ=t_{f}) [Equation 4]

In Equation 4, a moving distance from the step start point to the step end point is a unit moving distance. Here, when acquiring the moving distance from the step start point to the step end point, a moving speed is acquired by integrating the detected acceleration and a moving distance is acquired by integrating again the moving speed. Here, when the moving speed is not initialized, an error occurs in the moving speed according to the detected acceleration, and the speed error may be sequentially accumulated. When integrating a moving speed including the accumulated error, accumulative error of the moving distance exponentially increases. Therefore, as a total moving distance increases, an error value increases and thus an accurate moving distance cannot know. According to am embodiment of present invention, as shown in FIG. 15, by initializing a moving speed every step, a cumulative error of the speed is removed and thus a moving distance can be more accurately measured.

Referring to FIG. 8, the device for measuring a moving distance 100 acquires health management information including a total moving distance by adding up the acquired unit moving distances (S106). Here, the health management information may include at least one of a total moving distance, a stride, the total number of steps, an exercise amount, consumption calorie, and an exercise time. The controller 170 acquires a plurality of unit moving distances by repeating a method of acquiring a unit moving distance. Further, the controller 170 acquires a total moving distance by adding up the acquired plurality of unit moving distances. This is represented by Equation 5.

ΔD=ΣΔs_{if} [Equation 5]

In Equation 5, ΔD is a total moving distance and is acquired by adding up unit moving distances. Alternatively, the controller 170 may acquire a moving speed based on acceleration detected by the sensor module 150, initialize a moving speed every step start point to a predetermined value, and acquire a total moving distance by integrating a moving speed over an entire moving time with respect to a time. When adding up unit moving distances or initializing a moving speed every step start point and acquiring a total moving distance using acceleration, an error at every start point is removed and resulting in minimizing an accumulative error. As such, the device for measuring a moving distance 100 can acquire an accurate total moving distance.

Further, the controller 170 calculates the total number of steps by counting the quantity of step start points and generates other health management information using the acquired total moving distance and health management information stored in the storage unit 160. For example, the controller 170 may acquire an exercise amount or consumption calorie based on a total moving distance, a user's weight, and a kind of moving modes. Further, the controller 170 may acquire an average unit moving distance based on a total moving distance and the total number of steps.

Next, the device for measuring a moving distance 100 outputs the acquired health management information and/or transmits the acquired health management information to an external device (S107). For example, the controller 170 controls the output unit 130 to output health management information, and/or controls the communication unit 140 to transmit the health management information to the mobile communication terminal 20 or the health management server 10. In this case, the information transmitted or outputted from the device for measuring a moving distance 100 may include at least one of a unit moving distance, an average unit moving distance, a moving mode, a total moving distance, an exercise amount, and consumption calorie.

Moreover, the mobile communication terminal 20 receives such information and displays the information to a user. For example, when the mobile communication terminal 20 may receive a signal that instructs to enter a moving distance measurement mode from the user and enter in a moving distance measurement mode the mobile communication terminal 20 provides the above information to the user. Alternatively, the device for measuring a moving distance 100 can be formed as a single device together with the mobile communication terminal 20.

As described above, the device for measuring a moving distance 100 performs communication with an external device. Hereinafter, a method of performing communication the device for measuring a moving distance 100 and the external device will be described.

An individual health equipment, such as the device for measuring a moving distance 100, performs communication with a manager device. In general, the individual health equipment has a low computing capability, whereas the manager device, such as a mobile communication terminal 20, a personal computer, and a set top box, has a storing place of stronger calculation performance and a larger capacity. The manager device communicates with the health management server 10 by sharing information with the individual health equipment supplementing its insufficient performance with the manager device. Further, when the individual health equipment performs only wired communication or local area communication, the individual health equipment shares information with the health management server 10 through the manager device.

Here, the individual health equipment and the manager device may include an application layer and a transport layer. The application layer may perform various functions related to a function of the health equipment. For example, the application layer of the device for measuring a moving distance 100 may measure a stride of the user and displays the stride on a screen. Further, the transport layer may receive and transmit information from the application layer. For example, the transport layer of the device for measuring a moving distance 100 may transmit information about a moving distance acquired by the application layer to the mobile communication terminal 20.

Moreover, the individual health equipment and the manager device may perform communication with a point to point method that includes steps of connecting the transport layers of the individual health equipment and the manager device, associating the application layers of the individual health equipment and the manager device, and transmitting and receiving, by the individual health equipment and the manager device, the health management information.

First, the transport layers of the individual health equipment and the manager device can be connected. Before the power is first supplied to the individual health equipment, the individual health equipment is in a disconnected state. In this disconnected state, information cannot be exchanged between the transport layers of the individual health equipment and the manager device. When the individual health equipment of the disconnected state receives a transport connect display message from the manager device, the transport layers of the individual health equipment and the manager device become connected according to the transport connect display message. Then, when the transport layers of the individual health equipment and the manager device are connected, by entering a connected state, information can be transmitted and received between the transport layers.

The application layers of the individual health equipment and the manager device may be associated. The connected state includes an unassociated state, an associating state, and an associated state. The associated state is a state that can transmit and receive information as the application layers of the individual health equipment and the manager device form a logical path for exchanging information. For example, the associated device for measuring a moving distance 100 may transmit and receive health management information to the mobile communication terminal 20. In the associating state, the individual health equipment and the manager device of an unassociated state perform an operation to be associated. Here, in the unassociated state, the transport layers of the individual health equipment and the manager device are first connected, but the application layer may be in an unassociated state. The individual health equipment and the manager device of the unassociated state cannot exchange information of the application layer.

As described above, in order for the individual health equipment of an unassociated state to be associated with the manager device, the individual health equipment may enter an associating state. The individual health equipment and the manager device of the associating state perform an associating procedure to be associated is executed. The associating procedure includes transmitting, by the individual health equipment, an association request message to the manager device, receiving, by the manager device, the association request message, generating, by the manager device, an association response message to the received association request message, receiving, by the individual health equipment, the association request message, and associating, by the individual health equipment, with the manager device according to the received association request message. Hereinafter, steps included in the associating procedure will be described.

Furthermore, the individual health equipment may transmit the association request message to the manager device. Here, the association request message includes a version of the association protocol and a data protocol list for at least one data protocol in which the individual health equipment supports. Further, the data protocol list includes at least one data protocol information and a data protocol ID for identifying a kind of the data protocol.

Here, the data protocol ID may identify a type of the data protocol that the individual health equipment supports. For example, the data protocol ID may be information identifying whether or not a data protocol that the individual health equipment supports is a data protocol of a predetermined specification or a data protocol according to a specification in which an individual health equipment manufacturer separately provides. Here, the predetermined specification may include, for example, ISO/IEEE 11073 standard.

Further, the data protocol information may include information about the the data protocol according to the data protocol ID. The data protocol information includes a version of a data exchange protocol in which the individual health equipment supports, at least one encoding rule for an application protocol data unit in which the individual health equipment supports, a version of the nomenclature in which the individual health equipment supports, all functional units and an optional feature in which the individual health equipment supports, a system ID for uniquely identifying the individual health equipment, and a device configuration ID for identifying a current configuration of the individual health equipment.

Then, the manager device may receive the association request message to generate an association response message. Here, the association response message includes a result field reflecting a result of the association procedure, a version of a data protocol selected by the manager device among data protocols supported by the individual health equipment included in the data protocol list, an encoding rule selected by the manager device among encoding rules in which the individual health equipment supports, a version of the nomenclature selected by the manager device, a system ID for uniquely identifying the manager device, and a manager device configuration response for identifying a current configuration of the manager device.

Here, the version of the data protocol and the version of the encoding rule and the nomenclature may have a value that selects a data protocol, an encoding rule, and a nomenclature in which the manager device commonly supports among a data protocol, an encoding rule, and a nomenclature in which the individual health equipment supports based on the association request message. For example, when the association protocol, the data protocol, the encoding rule, and the nomenclature included in the association request message include an association protocol, a data protocol, an encoding rule, and a nomenclature in which the manager device supports, the manager device may accept the association. In this case, the result field has a value reflecting that association is accepted. If an association protocol, a data protocol, an encoding protocol, and a nomenclature included in the association request message do not include at least one of an association protocol, a data protocol, an encoding protocol, and a nomenclature in which the manager device supports, the manager device rejects association. In this case, the result field has a value reflecting that association is rejected. The manager device transmits the generated association response message to the individual health equipment.

Further, the individual health equipment may receive an association response message from the manager device. In this case, the individual health equipment receives an association response message for a predetermined time period. When the individual health equipment does not receive an association response message for a predetermined time period, the individual health equipment transmits again an association request message to the manager device. In this case, when the individual health equipment does not receive again an association response message for a predetermined time period, the individual health equipment abandons association and returns from an associating state to an unassociated state. In this case, the individual health equipment transmits an association abort message to the manager device. When the manager device transmits an association abort message, the manager device is changed from the associating state to the unassociated state.

The individual health equipment may be associated with the manager device in consideration of the received association response message. For example, when a result field of the association response message has a value reflecting that association is rejected, the individual health equipment abandons association and returns to an unassociated state. Specifically, for example, when an association protocol, a data protocol, and a set of operating parameters do not agree, or when the individual health equipment is not an authenticated equipment, the individual health equipment and the manager device may not be associated.

For another example, when a result field of the association response message has a value reflecting that association is accepted, the individual health equipment is associated with the manager device according to the association protocol. Here, when the manager device knows a configuration of the individual health equipment, the application layers of the manager device and the individual health equipment are directly associated. Further, when the manager device does not know a configuration of the individual health equipment, the individual health equipment transmits information about a configuration of the individual health equipment to the manager device, and thus the application layers of the manager device and the individual health equipment are associated.

Thereby, the individual health equipment and the manager device can perform communication for health management information by entering an associated state. Further, the user can acquire health management information through an exercise and perform an exercise or adjust an exercise amount in consideration of the health management information. Further, by transmitting and sharing the information to the mobile communication terminal 20 or the health management server 10, more systematic and comprehensive health management can be performed. Accordingly, more healthy society can be obtained.

The embodiments of the present invention may include many variations and modifications of the basic inventive concepts herein described, which may appear to those skilled in the art, will still fall within the spirit and scope of the exemplary embodiments of the present invention as defined in the appended claims.

What is claimed is:

1. A device for measuring a moving distance, comprising:
a mounting module to be attached to a specific portion of a moving object;
a sensor module configured to sense an acceleration of the moving object;
a controller configured to calculate each of a plurality of unit moving distances between a plurality of substantial stop states based on the acceleration of the moving object, and calculate a total moving distance by adding up the plurality of unit moving distances, wherein at least one of the plurality of substantial stop states occurs when an absolute value of the acceleration is smaller than a predetermined threshold value; and
a communication unit configured to transmit information including the moving speed and the total moving distance, and receive health information.

2. The device of claim 1, wherein the controller is further configured to obtain a time point including a step start point and a step end point of the at least one of the plurality of substantial stop states based on the acceleration, to initialize a moving speed of the step start point to a predetermined value, to determine a moving speed from the step start point to the step end point based on the acceleration from the step start point to the step end point and the initialized moving speed of the step start point, and to calculate the each of the plurality of the unit moving distances based on the moving speed from the step start point to the step end point.

3. The device of claim 2, wherein when an absolute value of the acceleration is smaller than the predetermined threshold value, the controller obtains the time point of the at least one of the plurality of substantial stop states.

4. The device of claim 3, further comprising:
an input module configured to receive an input,
wherein the controller receives a moving mode through the input module, and the moving mode includes at least one of a walking mode, a race-walking mode, a running mode, a stair-ascending mode, and a stair-descending mode.

5. The device of claim 4, wherein the controller determines the predetermined threshold value based on the moving mode.

6. The device of claim 5, wherein the predetermined threshold value of the walking mode is smaller than the predetermined threshold value of the race-walking mode, and the threshold value of the race-walking mode is smaller than a threshold value of the running mode.

7. The device of claim 2, wherein when the absolute value of the acceleration is smaller than the predetermined threshold value for a predetermined time period, the controller obtains the time point of the at least one of the plurality of substantial stop states.

8. The device of claim 7, further comprising:
an input module configured to receive an input,
wherein the controller receives a moving mode through the input module, and the moving mode includes at least one of a walking mode, a race-walking mode, a running mode, a stair-ascending mode, and a stair-descending mode.

9. The device of claim 8, wherein the controller determines a predetermined time period based on the moving mode.

10. The device of claim 2, wherein the acceleration includes a horizontal acceleration and a vertical acceleration, and
wherein when the vertical acceleration is substantially constant for a predetermined time period, the controller obtains the time point of the at least one of the plurality of substantial stop states determines the each of the plurality of the unit moving distances using the initialized moving speed of the step start point and the horizontal acceleration from the step start point to the step end point.

11. The device of claim 2, wherein the controller is further configured to measure a speed difference between the step start point and the step end point by integrating acceleration from the step start point to the step end point with respect to a time, to measure the moving speed from the step start point to the step end point based on the moving speed of the step start point and the speed difference, and to calculate the unit moving distance by integrating the moving speed from the step start point to the step end point with respect to a time.

12. The device of claim 2, wherein the controller calculates a total number of steps based on a number of the step end points.

13. A method of measuring a moving distance, the method comprising:
installing a device to a moving object via a mounting module of the device;
selecting a moving mode on the device;
sensing an acceleration of the moving object via a sensing module of the device;
calculating each of a plurality of unit moving distances using the sensed acceleration and the selected moving mode; and
calculating a total moving distance by adding up the plurality of unit moving distances.

14. The method of claim 13, the step of calculating each of a plurality of unit moving distances further comprising:
obtaining a time point of at least one of a plurality of substantial stop states based on the acceleration, the time point of the at least one of the plurality of substantial stop states including a step start point and a step end point;
initializing a moving speed at the step start point to a predetermined value;
determining the moving speed from the step start point to the step end point based on the acceleration from the step start point to the step end point and the initialized moving speed of the step start point; and
calculating the each of the plurality of the unit moving distances based on the moving speed from the step start point to the step end point

15. The method of claim 13, the step of calculating each of the plurality of unit moving distances further comprising:
obtaining the time point of the at least one of the plurality of substantial stop states when an absolute value of the acceleration is smaller than a threshold value or when an absolute value of the acceleration is smaller than the threshold value for a predetermined time period.

16. The method of claim 13, wherein the acceleration includes a horizontal acceleration and a vertical acceleration, and
wherein when the vertical acceleration is substantially constant for a predetermined time period, the controller obtains the time point of the at least one of the plurality substantial stop states and determines the each of the plurality of the unit moving distance using the initialized moving speed of the step start point and the horizontal acceleration from the step start point to the step end point.

17. A method of measuring a moving distance, the method comprising:
installing a device to a moving object via a mounting module of the device;
selecting a moving mode on the device;
sensing an acceleration of the moving object via a sensing module of the device;
obtaining a time point of the at least one of a plurality of substantial stop states based on the acceleration, the time point of the at least one of the plurality of substantial stop states including a step start point and a step end point;
initializing a moving speed of the step start point to a predetermined value;
determining the moving speed from the step start point to the step end point based on the acceleration and the moving speed of the step start point;
calculating each of the plurality of the unit moving distances based on the moving speed of the step start point and the acceleration from the step start point to the step end point; and
calculating a total moving distance by adding up the plurality of unit moving distances.
